(19) United States
(12) Patent Application Publication
(10) Pub. No.: US 2018/0050279 A1
(43) Pub. Date: Feb. 22, 2018

(54) Methods for Treating Used Oil Vacuum Tower Bottoms

(71) Applicant: Noble Oil Services, Inc., Sanford, NC (US)

(72) Inventors: James Joseph Noble, Cary, NC (US); James Ray Hanrahan, Slidell, LA (US)

(21) Appl. No.: 15/241,819

(22) Filed: Aug. 19, 2016

(51) Int. Cl. B01D 3/08; C10G 7/00

(52) U.S. Cl. CPC B01D 3/085; C10G 7/003; C10G 7/006; C10G 2300/4006; C10G 2300/1074; C10G 2300/1077; C10G 2300/1007

(57) ABSTRACT

Methods of processing used oil vacuum tower bottoms in a heated chamber. The used oil vacuum tower bottoms are introduced into the chamber as a liquid. The used oil vacuum tower bottoms are introduced in a first section of the heated chamber. The used oil vacuum tower bottoms pass along the length of the chamber through a series of sections that are each heated to different temperatures. The sections may have varying lengths and may be heated to a variety of different temperatures. As the used oil vacuum tower bottoms progress along the length of the chamber, hydrocarbons are removed resulting in an outputted product that is substantially free of hydrocarbons and that has a substantially granular form. Vapor from the process is further captured producing vacuum gas oils.

### BACKGROUND

Oils are used in a variety of different industrial applications. These applications may include but are not limited to high viscosity lubricants, such as for locomotives, heavy trucks, and generators, and motor oils to reduce engine wear in various devices. The various oils have an expected useful life and then are replaced with new oil. This used oil contains a variety of contaminants, such as polymers added to increase the protective nature of the oil, anti-friction additives, anti-wear additives, viscosity modifiers, as well as metals from the engine, ash from combustion and contaminants from the collection processes.

The used oil may be re-refined to obtain useful components contained within the oil. An initial process of the re-refining may include distillation that separates the used oil into the different components. This distillation includes moving the used oil through one or more distillation towers that are at atmospheric pressure or under a vacuum. To facilitate the refining process, the used oil may be initially heated prior to introduction into the first tower. Components that are in vapor form rise up the tower through a series of distillation stages, while components that are still in liquid form fall to the bottom. The bottom components from the tower (dehydrated, defueled feedstock) are then heated and introduced into a subsequent tower under vacuum.

The remaining material at the bottom of the vacuum distillation tower is referred to as used oil vacuum tower bottoms (used oil VTB). This material is also referred to as recycled engine oil bottoms and vacuum tower asphalt extender. This material includes a high proportion of contaminants thus limiting its effective use.

### SUMMARY

The present application is directed to methods of processing used oil vacuum tower bottoms (VTB) in a heated chamber. This may include progressively heating the used oil VTB as it moves along the length of the chamber. As the used oil VTB progresses along the length of the chamber, the used oil VTB is heated to a point where the oil contained in it begins to vaporize. The output of the distillation unit includes a vapor that is collected and condensed into a liquid, and a solid, granular component that is substantially free of hydrocarbons.

One embodiment is directed to a method of distilling used oil VTB including introducing used oil vacuum tower bottoms into a rotating chamber and moving the used oil VTB through sections of the chamber that each extend along a different longitudinal length of the chamber. The method includes elevating the temperature of the used oil VTB while moving the used oil VTB through the sections and along the longitudinal length of the rotating chamber. The method includes capturing a first portion of the used oil VTB from the chamber that is vaporized as the used VTB move along the longitudinal length of the rotating chamber, and removing flux solids from the chamber that remain from the used oil VTB after the used oil VTB have moved through the sections.

The method may also include heating the chamber sections successively hotter from where the used oil VTB is introduced being at the lowest temperature and a last chamber section where in flux solids are removed being at the highest temperature.

The method may include heating the first chamber section to a first temperature that is above ambient temperature and below a temperature that would cause coking of the used oil VTB onto inner walls of the chamber.

The method may include spreading the used oil VTB over the inner walls of the chamber in the first section.

The method may include moving the used oil VTB over partitions that extend inward into the chamber from the inner walls and that separate the sections of the chamber.

The method may include convectively heating the chamber.

The method may include condensing the first portion of the used oil VTB to produce light and medium vacuum gas oil.

Another embodiment is directed to a method of distilling used oil VTB. The method includes introducing used oil VTB into a rotating chamber and moving the used oil VTB through a first section that extends along a first longitudinal length of the chamber with the first section being heated to a first temperature. The method includes moving the used oil VTB along the chamber from the first section and through a second section that extends along a second longitudinal length of the chamber with the second section being heated to a higher second temperature. The method includes moving the used oil VTB along the chamber from the second section and through a third section that extends along a third longitudinal length of the chamber with the second section being heated to a third temperature that is higher than the second temperature. The method includes capturing a first portion of the used oil VTB that is vaporized as the used oil VTB move along the chamber, and removing flux solids from the chamber that remain from the used oil VTB after the used oil VTB have moved through the third section.

The method may include heating the chamber in a gradient between 500° F. and 1100° F.

The method may include condensing the portion of the used VTB that is vaporized into light and medium vacuum gas oil.

The method may include pre-heating the used oil VTB to above ambient temperature and below the temperature in the first chamber zone, prior to introducing the used oil VTB into the chamber.

The method may include convectively heating the chamber by preventing flame from a heat source from directly contacting against the chamber.

The method may include introducing the used oil VTB into the rotating chamber including spraying the used oil VTB onto an inner wall of the first section of the chamber.

The method may include that the first section is at a first longitudinal end of the chamber and the third section is at an opposing second longitudinal end of the chamber.

Another embodiment is directed to a method of distilling used oil VTB that include heating each longitudinal section of an enclosed chamber to different temperatures with the temperatures continuously increasing along a length of the chamber from a first section to a last section. The method includes introducing used oil VTB into the chamber and moving the used oil VTB through the first section and heating the used oil VTB. The method includes moving the used oil VTB through one or more intermediate sections of the chamber and increasingly elevating the temperature of the used oil VTB. The method includes moving the used oil VTB through the last section and further elevating the temperature of the used oil VTB, and removing flux solids from the chamber that remain from the used oil VTB after the used oil VTB have moved through the last section.

The method may include introducing the used oil VTB in the first section of the chamber.

The method may include rotating the chamber while the used oil VTB are moving through the chamber.

The method may include capturing the used oil VTB that are vaporized as the used oil VTB move along the chamber.

The various aspects of the various embodiments may be used alone or in any combination, as is desired.

### BRIEF DESCRIPTION OF THE DRAWINGS

FIG. 1 is a schematic side view of a distillation unit.

FIG. 2 is a schematic side view of a distillation unit.

FIG. 3 is a schematic view of a chamber with partition walls spaced apart along the length.

FIG. 3A is a section view cut along line III-III of FIG. 2 of an interior of the chamber.

FIG. 4 is a schematic end view of a chamber positioned within a shield.

FIG. 5 is a flowchart diagram of a process of distilling used oil vacuum tower bottoms.

### DETAILED DESCRIPTION

The present application is directed to methods of processing used oil vacuum tower bottoms (VTB) in a heated chamber. The used oil VTB is introduced into the chamber while in a liquid form. The used oil VTB is introduced in a first section of the heated chamber. The used oil VTB passes along the length of the chamber through a series of sections that are each heated to different temperatures. The sections may have varying lengths and may be heated to a variety of different temperatures. This may include progressively heating the used oil VTB as it moves along the length of the chamber. As the used oil VTB progresses along the length of the chamber, the used oil VTB is heated to a point where the oil contained in it begins to vaporize. The output of the distillation unit includes a vapor that is collected and condensed into a liquid, and a solid, granular component that is substantially free of hydrocarbons.

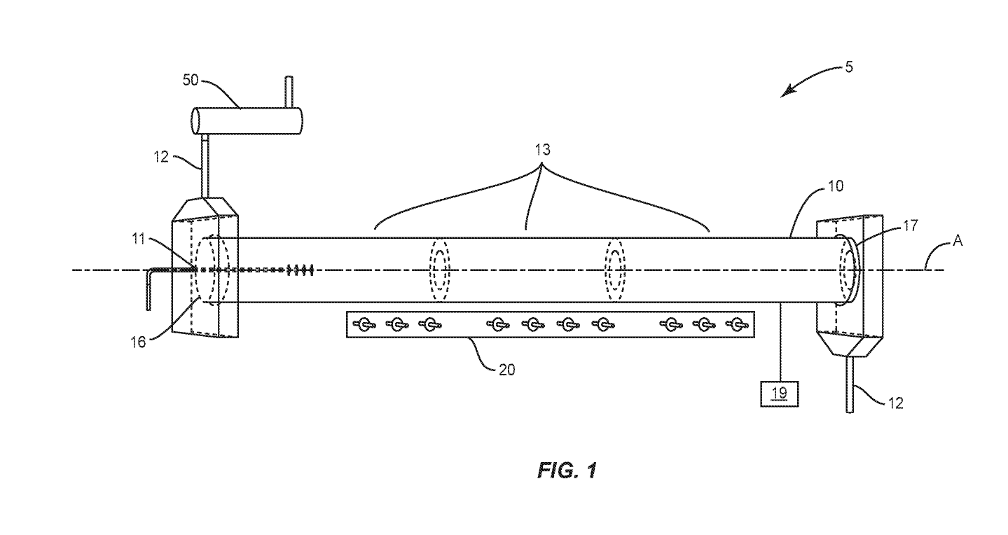

FIG. 1 schematically illustrates a distillation system 5 that generally includes an elongated chamber 10 with a length and one or more inlets 11 and outlets 12. The system 5 also includes a heat source 20 to heat the chamber 10. The heat source 20 is configured to form different heating sections 13 along the length of the chamber 10 between the one or more inlets 11 and outlets 12. The chamber 10 is rotated by a motor 19 about a longitudinal axis A at a variety of different rotational speeds.

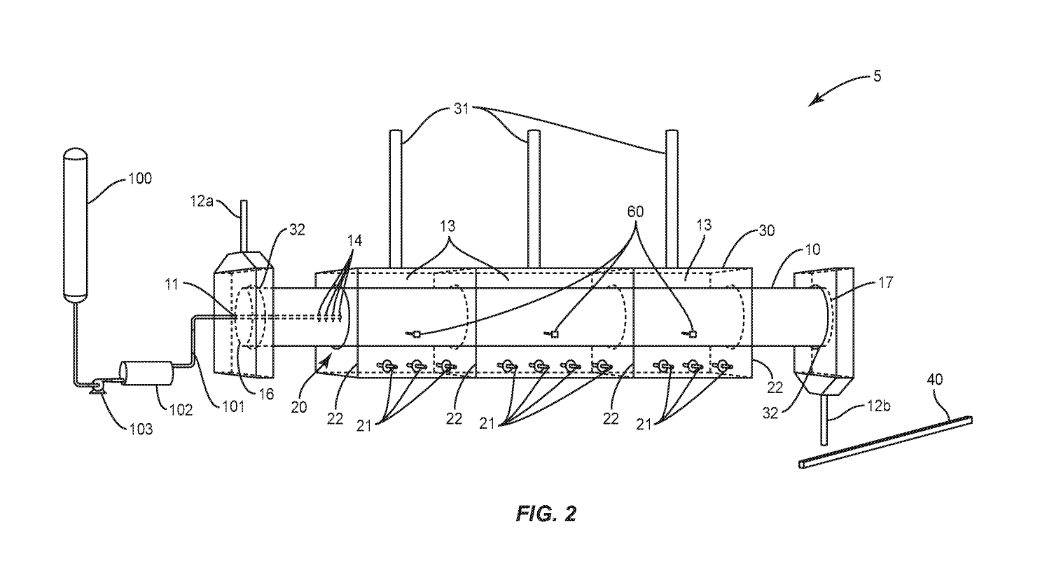

An initial heating section 13 in proximity to the inlet 11 is set at a relatively low temperature. This reduced temperature prevents the used oil VTB from coking onto the inner surface of the chamber 10 by adjusting its viscosity to allow better flow before heating it to its cracking point. This is particularly true when the used oil VTB is initially contacted against the inner walls of the chamber 10. In one embodiment as illustrated in FIG. 1, the initial heating section 13 is spaced away from the inlet 11 along the length of the chamber 10. As further illustrated in FIG. 2, the area of the chamber 10 where the used oil VTB is initially introduced is positioned away from the initial heating section 13.

The subsequent heating sections 13 along the length of the chamber 10 have increasingly higher temperatures. The higher temperatures provide for additional vaporization and break-down of the used oil VTB. Vapor produced during the process may be removed through a first outlet 12, with the solid component removed through a second outlet 12.

FIG. 2 includes a more detailed view of a distillation system 5. As illustrated in FIG. 2, the chamber 10 may be positioned downstream from a distillation tower 100. The remnant used oil VTB from the tower 100 is moved along a pipe 101 by a pump 103 and into the chamber 10. The used oil VTB may be a liquid that is heated to an elevated temperature while in the tower 100 and while moved along the pipe 101 and into the chamber 10. One or more heat sources 102 may further heat the used oil VTB prior to introduction into the chamber 10. The used oil VTB may be introduced into the chamber 10 at a variety of different temperatures, including a range of between ambient temperature to 650° F.

The used oil VTB is introduced into the chamber 10 while in a liquid form. This may include introduction through one or more spray heads 14 that spray the used oil VTB onto the inner wall of the chamber 10. The spray heads 14 coat the inner surface of the chamber 10 as the chamber 10 is being rotated.

The used oil VTB may also be introduced as a stream through an end of the inlet pipe 101. The used oil VTB is emitted from the end of the pipe 101 and falls onto the heated inner wall of the chamber 10. The chamber 10 is rotated as the used oil VTB is introduced. This provides for distributing the used oil VTB along the inner wall of the chamber 10.

The chamber 10 may include various shapes and sizes. In one embodiment, the chamber 10 has a cylindrical shape with a length measured between the opposing ends 16, 17. The length of the chamber 10 may vary, with one embodiment including a length of about 45 feet. The inner wall of the chamber 10 may include a circular cross-sectional shape. This causes the used oil VTB to flow along the inner wall of the chamber 10 during rotation. Chamber 10 may also include an inner wall with non-circular cross-sectional shapes.

The inlet 11 and outlet 12 may be positioned at various locations along the chamber 10. As illustrated in FIGS. 1 and 2, the inlet 11 may be positioned at a first end 16, and the outlet 12 and the opposing end 17. Other arrangements may also be included with the inlets 11 and outlets 12 at various positions. Further, the chamber 10 may include multiple inlets 11 and/or outlets 12. FIG. 2 includes a first outlet 12 along an upper section of the chamber 10 for removal of vapors and a second outlet 12 along a lower section for removal of solids. Regardless of this positioning and/or number, the process is configured for moving the used oil VTB along the length L of the chamber 10 and through the multiple heating sections 13 with the output including both vapors and solids.

The motor 19 rotates the chamber 10 at a variety of speeds. In one embodiment, the motor 19 is able to rotate the chamber 10 at speeds between 0-15 revolutions per minute. The rotational speed of the chamber 10 affects the speed of the movement of the used oil VTB through the chamber 10. Thus, a slower rotational speed results in a slower movement of the used oil VTB. Conversely, a higher rotational speed results in a higher movement along the length of the chamber 10.

The chamber 10 may be kept at a slight negative pressure. This slight negative pressure prevents the escape of flammable vapors produced during the process that would occur if the chamber was not pressurized or was under a positive pressure. The slight negative pressure is also set to limit outside air from being pulled into the chamber, which could occur become excessive under a larger negative pressure.

The heat source 20 is configured to heat each of the sections 13 to a different temperature. The heat source 20 may include one or more burners 21 as illustrated in FIG. 2. The burners 21 are positioned along the length L of the chamber 10 such that one or more burners 21 are located along each heating section 13. The burners 21 may be individually controlled to adjust the heating of the chamber 10 along each heating section 13. The burners 21 may be powered by various means, including natural gas, produced vapors, fuel oils or electricity. In one embodiment, 3-4 burners 21 are located along each section 13. The heat source 20 may be configured to heat just a limited length of the chamber 10. As illustrated in FIG. 2, the heat source 20 does not extend along an initial length at the inlet 11 and a final length on the opposite end of the chamber 10.

The heat source 20 convectively heats the chamber 10. Hot gasses produced by the heat source 20 are moved along the outer surface of the chamber 10 thus heating the different sections 13. The heat source 20 is further positioned to direct the flame away from directly contacting against the chamber 10. A barrier may be positioned between the heat source 20 and the chamber 10 to direct flames from directly contacting against the chamber 10. The use of convective heating and preventing flame from directly contacting against the chamber 10 further reduce coking of the used oil VTB and extends equipment life.

As illustrated in FIG. 2, an enclosure 30 may extend around and enclose the chamber 10. The enclosure 30 is fixed in position and does not rotate with the chamber 10. The enclosure 30 captures the emissions from the heat source 20 and diverts the emissions through one or more outlets 31. The enclosure 30 may include interior walls 22 that extend around the chamber 10 and further define the heating zones 13. The enclosure 30 maintains the heat against the chamber 10 and also facilitates heating around the entire exterior surface.

One or more temperature sensors 60 determine the temperature of the used oil VTB as it moves through the chamber 10. The sensors 60 may include temperature probes positioned within the interior of the chamber 10 that sense the temperature of the used oil VTB. Another sensor 60 is configured to sense the temperature of the exterior of the chamber 10 which may then be used to calculate the temperature of the used oil VTB. Another sensor 60 is configured to sense an exit gas temperature which is used to calculate the used oil VTB. Temperature sensors 60 may also be located on the exterior of the chamber 13, such as within the enclosure 30. The outside sensors 60 measure the temperature of the combustion areas.

The number of heating sections 13 along the length L of the chamber 10 may vary. FIG. 2 includes a chamber 10 with three heating sections 13, although the chamber 10 may only include one heating section, or more than three heating sections. The heating sections 13 may extend along the entire length of the chamber 10 as illustrated in FIG. 2. The sections 13 may be adjacent to one another such that the used oil VTB moves from one section 13 directly into the next section 13 as it moves along the length of the chamber 10. Alternatively, one or more non-heated sections may also be positioned along the length. For example, a non-heated section may be positioned at the outlet 12 thus allowing for the solid, granulated component to begin cooling prior to being outputted from the chamber 10. The various heated sections 13 and non-heated sections may include various lengths that may each be the same or different.

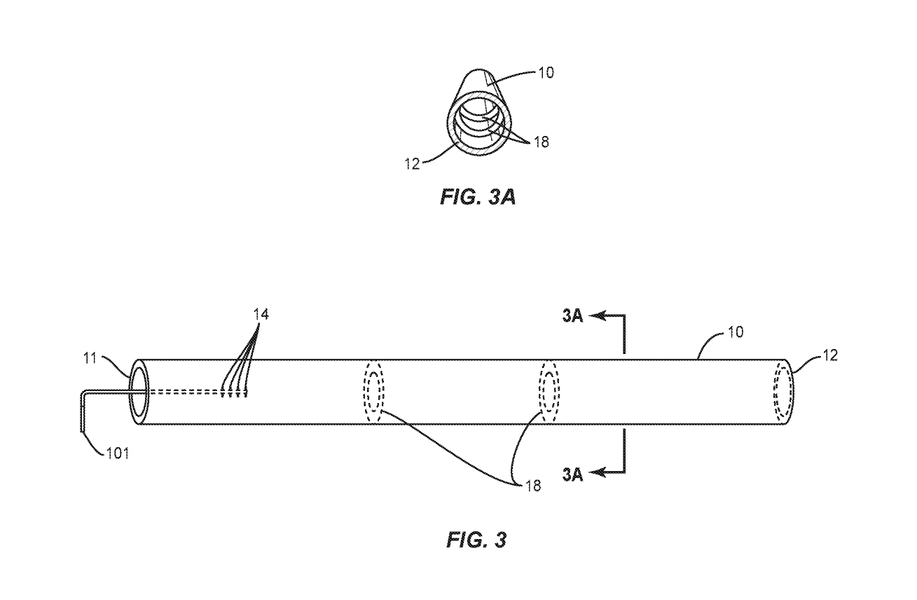

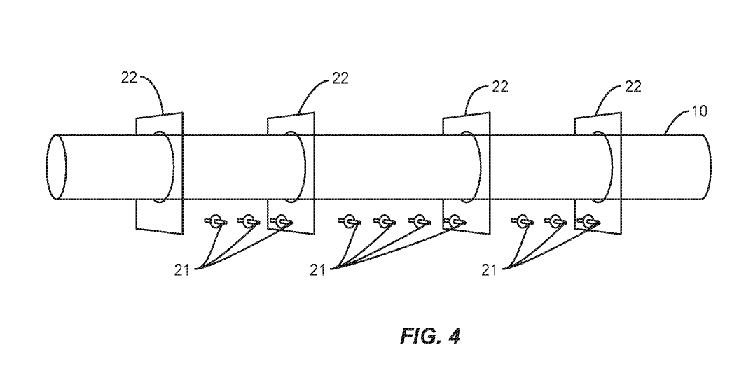

As illustrated in FIGS. 3 and 3A, the chamber 10 may include partition walls 18 that extend inward from the inner wall of the chamber 10 and define the heating sections 13. The partitions 18 may have a limited height thus preventing the used oil VTB from freely flowing from a first section 13 to a second section 13 along the chamber length. The partitions 18 control the progress of the used oil VTB along the length of the chamber 10 and that the used oil VTB is processed appropriately at each section 13. In one embodiment, each wall 18 extends inward about four inches from the inner side of the chamber 10.

The chamber 10 may be configured for the used oil VTB to accumulate at each partition 18 eventually resulting in the used oil VTB moving over the top of the partition 18 and into the subsequent heating section 13. Alternatively or in addition, one or more of the partitions 18 may include openings to allow passage of the used oil VTB. Alternatively or in addition, there may be attachments on the inner surface of chamber 10 within sections 13, intended to create turbulence, retain or rotate product within the sections 13.

In one specific embodiment, the chamber 10 includes a length L between 40-45 feet. A pair of partition walls 18 are equally spaced along the length L to form three separate heating sections 13.

The chamber 10 is configured to move the used oil VTB along the length of the chamber 10 during rotation. As illustrated in FIG. 1, this may include the chamber 10 being aligned with the first end 16 being elevated relative to the second end 17. This orientation provides for the used oil VTB to move along the length of the chamber 10 after being introduced in proximity to the first end 16.

In addition to or instead of the angular orientation, the chamber 10 may be equipped with helical fins that extend inward along the inner wall of the chamber 10. As the chamber 10 rotates, the helical fins move the used oil VTB along the length. A screw conveyor may also be positioned within the interior of the chamber 10 to move the used oil VTB. The screw conveyor may be located along a lower section of the chamber 10. The fins and screw conveyor may extend the entire length of the chamber 10, or may extend along a limited section of the length. In one embodiment, the screw conveyor is positioned only in proximity to the outlet 12. The outlet 12 may be positioned to deposit the solid material into a conveyor 40.

The used oil VTB is distilled into vapors and solids during the process. The vapors rise in the chamber 10 and are outputted through one or more of the outlets 12. As illustrated in FIG. 1, one or more condensers 50 further process the vapors. In one embodiment, the distillation system 5 includes a single condenser 50. In another, the condenser 50 includes four separate units that operate at different temperatures to fractionate the distillate. The condenser 50 may include one or more of a wet scrubber type condenser and a shell and tube exchanger type condenser. The condenser 50 may operate at temperatures ranging from 350° F. to sub-ambient. The vapor may also be moved through filters that remove additional contaminants, such as metals that were contained in the used oil VTB.

The distillation system 5 may include a variety of different configurations and settings. In one specific embodiment, the heat source 20 includes three independent heating sections 13. Each section 13 is equipped with 1-4 linked burners 21 for adjusting the heat. The sections 13 are heated to temperatures between 500° F.-1100° F.

The temperatures of the sections 13 vary depending upon the feed rate and the composition of the used oil VTB. The heating sections 13 are consecutive resulting in the feed rate through the first section 13 is carried into the other sections 13. However, the sections 13 have different loads. In an embodiment with three sections 13, the first section 13 is a preheat area that elevates the temperature of the used oil VTB. The second section 13 with the higher temperature causes a majority of the vaporization of the used oil VTB. The third section is a polishing area that removes remaining hydrocarbons from the remaining granulated solids. The overall feed rate through the unit 5 may vary, with examples including from 0-5 tons per hour.

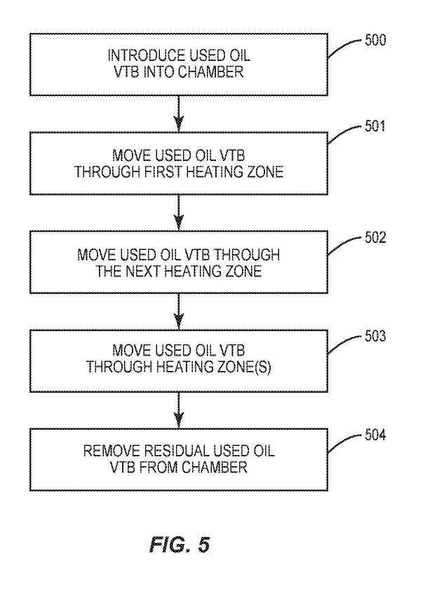

FIG. 5 illustrates a method of processing used oil VTB. The used oil VTB is introduced into the chamber 10 (block 500). The used oil VTB may be at ambient temperature, or may be heated prior to introduction up to 650° F.

The liquid used oil VTB may be introduced through one or more sprayer heads 14 that spray the VTB onto the inner wall of rotating the chamber 10. The chamber is rotating during the introduction thus distributing the used oil VTB along the chamber wall. The used oil VTB may also be introduced as a stream through an inlet pipe. The used oil VTB exits the inlet pipe and falls onto the inner wall of the chamber 10 where it spreads out over the inner wall of the chamber 10.

The chamber 10 is indirectly heated with a heat source 20 with no flames from the source 20 contacting against the chamber 10. The heat source 20 includes one or more burners 21 within each of the heating sections 13. The heat source 20 uses convective heating to heat the chamber 10, and does not directly heat the chamber 10. Hot gasses produced by the heat source 20 pass over the exterior surface of the chamber 10 thus heating the different sections 13.

The first heating section 13 is heated to a first temperature that prevents/reduces the used oil VTB from coking onto the inner wall of the chamber 10 (which would occur if the inner wall of the chamber was at a higher temperature). This first heating section 13 may be at the inlet 11, or may be spaced along the length of the chamber 10 away from the inlet 11. In one embodiment, the first heating section 13 acts as a pre-heating area to elevate the temperature of the used oil VTB for distillation in the subsequent heating sections 13. While in the first section, the used oil VTB moves along the chamber 10 and is heated due to the contact against the chamber wall (block 501).

The used oil VTB may be moved along the chamber 10. This may be caused by the chamber 10 being aligned at an angle with the first end 16 where the used oil VTB is introduced being vertically higher than the opposing second end 17. This may also be caused by one or more helical fins that extend along the chamber 10. The rotation of the chamber 10 during the process facilitates material movement towards the second end 17.

After passing through the first section and being heated a first amount, the used oil VTB enters into the next heating section 13. A partition wall 18 may be positioned at the boundary of the heating sections 13. Movement into the next heating section 13 requires the used oil VTB to move through and/or over the partition 18.

The used oil VTB moves along the next heating section 13 and remains in contact with the chamber wall resulting in heating to a higher temperature (block 502). This heating section 13 may result in a large amount of vaporization of the used oil VTB. The resulting vapors are captured and may be filtered to remove contaminants. The vapors are condensed resulting in vacuum gas oils, including light and medium distillates.

The used oil VTB continues the movement along the length of the chamber 10. This may include movement through a wide variety of different sections 13 and elevation to various temperatures (block 503). In one embodiment, each subsequent heating section 13 is at a higher temperature. At each section, the heating and movement due to the rotation distills or cracks the used oil VTB to vaporize hydrocarbons. Further, the remaining used oil VTB changes form while moving along the chamber 10 from an initial liquid with a first viscosity, to a higher viscosity liquid, and finally to a solid having a granular consistency. The remaining used oil VTB includes material that has not vaporized and is a solid, non-toxic solid-flux ash. This remaining used oil VTB is then removed from the chamber (block 504). This may include moving the remaining used oil VTB through the outlet 12, such as along a conveyor 40. The VTB may also be output due to one or more of the rotation of the chamber 10, helical fins that extend long the chamber interior, and the angular orientation of the chamber 10 with the outlet 12 being vertically lower than the inlet 11 thus providing for movement via gravity.

The composition of the used oil VTB introduced into the chamber 10 may vary. In one embodiment, 90% of the used oil VTB is distilled, and 10% remains as the residual used oil VTB in the form of solid-flux ash.

The speed of chamber rotation and movement of the used oil VTB through the chamber 10 may vary. In one embodiment, the feed rate ranges from 0-5 tons per hour.

Temperature sensors 60 may be positioned along the length of chamber 10. The rotational speed may be increased or decreased as necessary to obtain the desired output. For example, if a temperature sensor 60 indicates that the used oil VTB is below an expected temperature along one of the heating sections 13, the rotational speed may be slowed resulting in the used oil VTB remaining longer within the heating sections 13 and thus providing additional time to reach the expected temperature.

FIG. 2 illustrates the used oil VTB being moved from the distillation tower 100 into the chamber 10. The used oil VTB may also be moved from the tower 100 and into a storage tank prior to being introduced into the chamber 10.

Seals 32 may be positioned at various points along the chamber 10 to prevent the inadvertent escape of gasses. In one embodiment as illustrated in FIG. 2, seals 32 at the outer diameter of the chamber 13 are positioned at the vapor collection box and at the outlet 12.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive.

What is claimed is:

1. A method of distilling used oil vacuum tower bottoms comprising:
introducing used oil vacuum tower bottoms into a rotating chamber;
moving the used oil vacuum tower bottoms through sections of the chamber that each extend along a different longitudinal length of the chamber;
elevating the temperature of the used oil vacuum tower bottoms while moving the used oil vacuum tower bottoms through the sections and along the longitudinal length of the rotating chamber;
capturing a first portion of the used oil vacuum tower bottoms from the chamber that is vaporized as the used vacuum tower bottoms move along the longitudinal length of the rotating chamber; and
removing flux solids from the chamber that remain from the used oil vacuum tower bottoms after the used oil vacuum tower bottoms have moved through the sections.

2. The method of claim 1, further comprising heating the chamber sections successively hotter from where the used oil vacuum tower bottoms is introduced being at the lowest temperature and a last chamber section where in flux solids are removed being at the highest temperature.

3. The method of claim 2, further comprising heating the first chamber section to a first temperature that is above ambient temperature and below a temperature that would cause coking of the used oil vacuum tower bottoms onto inner walls of the chamber.

4. The method of claim 3, further comprising spreading the used oil vacuum tower bottoms over the inner walls of the chamber in the first section.

5. The method of claim 1, further comprising moving the used oil vacuum tower bottoms over partitions that extend inward into the chamber from the inner walls and that separate the sections of the chamber.

6. The method of claim 1, further comprising convectively heating the chamber.

7. The method of claim 1, further comprising condensing the first portion of the used oil vacuum tower bottoms to produce light and medium vacuum gas oil.

8. A method of distilling used oil vacuum tower bottoms comprising:
introducing used oil vacuum tower bottoms into a rotating chamber;
moving the used oil vacuum tower bottoms through a first section that extends along a first longitudinal length of the chamber, the first section being heated to a first temperature;
moving the used oil vacuum tower bottoms along the chamber from the first section and through a second section that extends along a second longitudinal length of the chamber, the second section being heated to a higher second temperature;
moving the used oil vacuum tower bottoms along the chamber from the second section and through a third section that extends along a third longitudinal length of the chamber, the second section being heated to a third temperature that is higher than the second temperature;
capturing a first portion of the used oil vacuum tower bottoms that is vaporized as the used oil vacuum tower bottoms move along the chamber; and
removing flux solids from the chamber that remain from the used oil vacuum tower bottoms after the used oil vacuum tower bottoms have moved through the third section.

9. The method of claim 8, further comprising heating the chamber in a gradient between 500° F. and 1100° F.

10. The method of claim 8, further comprising condensing the portion of the used vacuum tower bottoms that is vaporized into light and medium vacuum gas oil.

11. The method of claim 8, further comprising pre-heating the used oil vacuum tower bottoms to above ambient temperature and below the temperature in the first chamber zone, prior to introducing the used oil vacuum tower bottoms into the chamber.

12. The method of claim 8, further comprising convectively heating the chamber by preventing flame from a heat source from directly contacting against the chamber.

13. The method of claim 8, wherein introducing the used oil vacuum tower bottoms into the rotating chamber comprises spraying the used oil vacuum tower bottoms onto an inner wall of the first section of the chamber.

14. The method of claim 8, wherein the first section is at a first longitudinal end of the chamber and the third section is at an opposing second longitudinal end of the chamber.

15. A method of distilling used oil vacuum tower bottoms comprising:
heating each longitudinal section of an enclosed chamber to different temperatures with the temperatures continuously increasing along a length of the chamber from a first section to a last section;
introducing used oil vacuum tower bottoms into the chamber;
moving the used oil vacuum tower bottoms through the first section and heating the used oil vacuum tower bottoms;
moving the used oil vacuum tower bottoms through one or more intermediate sections of the chamber and increasingly elevating the temperature of the used oil vacuum tower bottoms;
moving the used oil vacuum tower bottoms through the last section and further elevating the temperature of the used oil vacuum tower bottoms; and
removing flux solids from the chamber that remain from the used oil vacuum tower bottoms after the used oil vacuum tower bottoms have moved through the last section.

16. The method of claim 15, further comprising introducing the used oil vacuum tower bottoms in the first section of the chamber.

17. The method of claim 15, further comprising rotating the chamber while the used oil vacuum tower bottoms are moving through the chamber.

18. The method of claim 15, further comprising capturing the used oil vacuum tower bottoms that are vaporized as the used oil vacuum tower bottoms move along the chamber.
